(19) United States
(12) Patent Application Publication
(10) Pub. No.: US 2015/0149012 A1
(43) Pub. Date: May 28, 2015

(54) DRIVE SYSTEM AND METHOD FOR CHARGING OF A BATTERY OF A HYBRID VEHICLE

(71) Applicant: Scania CV AB, Södertälje (SE)

(72) Inventors: Niklas Pettersson, Stockholm (SE); Mikael Bergquist, Hagersten (SE); Karl Redbrandt, Solna (SE); Mathias Björkman, Tullinge (SE); Johan Lindström, Nykoping (SE)

(21) Appl. No.: 14/410,601

(22) PCT Filed: Jun. 26, 2013
(86) PCT No.: PCT/SE2013/050782

§ 371 Date: Dec. 23, 2014

(30) Foreign Application Priority Data
Jun. 27, 2012 (SE) 1250717-4

(51) Int. Cl. B60W 20/00; B60W 10/26; B60W 10/08; B60W 10/06

(52) U.S. Cl. CPC B60W 20/106; B60W 10/06; B60W 10/26; B60W 10/08; Y10S 903/93
USPC 701/22; 180/65.265; 903/930

(57) ABSTRACT

A drive system and a method of driving a vehicle, wherein the drive system includes a combustion engine, a motor control function, a gear box, an electric machine, an energy storage and a planetary gear. A control unit receives information concerning the charge level of the energy storage and determines if the charge level is lower than a limit level such that the energy storage needs charging. If this is the case, the motor control function is controlled such that the combustion engine increases rotation speed in relation to the rotation speed when the energy storage does not need charging.

### CROSS-REFERENCE TO RELATED APPLICATIONS

The present application is a 35 U.S.C. §§ 371 National Phase conversion of PCT/SE2013/050782, filed Jun. 26, 2013, which claims priority of Swedish Patent Application No. 1250717-4, filed Jun. 27, 2012, the contents of which are incorporated by reference herein. The PCT International Application was published in the English language.

### BACKGROUND OF THE INVENTION AND PRIOR ART

The present invention concerns a drive system and a method of driving a vehicle.

A conventional clutch mechanism which disconnects the input shaft of the gear box from the combustion engine during gear changing processes in the gear box has disadvantages. When a stationary vehicle starts, the discs of the clutch mechanism slide against each other thereby heating the discs. This heating results in increased fuel consumption and wear of the clutch discs. A conventional clutch mechanism is also relatively heavy and expensive. It also occupies a relatively large space in the vehicle. Use of a hydraulic moment converter also results in losses.

Hybrid vehicles may be driven by a primary motor which may be a combustion engine and a secondary motor which may be an electric machine. The electric machine is equipped with at least one energy storage for storing electric energy and control equipment for controlling the flow of electric energy between the energy storage and the electric machine. The electric machine may thereby alternately work as a motor and a generator depending on the operation state of the vehicle. When the vehicle is braked, the electric machine generates electric energy which is stored in the energy storage. The stored electric energy is used later, for example, for driving the vehicle and operating different auxiliary systems in the vehicle.

The Swedish patent application SE 1051384-4, which has not been made public, shows a hybrid drive system with a planetary gear which comprises three components, namely a sun wheel, a planet wheel holder and a ring wheel. One of the three components of the planetary gear is connected to an output shaft of the combustion engine, a second component of the planetary gear is connected to an input shaft to the gear box and a third component of the planetary gear is connected to a rotor of an electric machine. The electric machine is connected to an energy storage such that it alternately works as a motor and a generator. The rotation speed of electric machines may be controlled in a stepless manner. By controlling the rotation speed of the electric machine, the input shaft to the gear box may be given a desired rotation speed. With a hybrid system according to SE 1051384-4, no clutch mechanism needs to be used in the drive line of the vehicle.

With such a hybrid system, no clutch mechanism needs to be used in the drive line of the vehicle. When the vehicle is driven at a low speed during a longer period, such as during shunting, there is a risk that the charge level of the energy storage becomes very low or that it is completely discharged.

### SUMMARY OF THE INVENTION

The object of the present invention is to provide a drive system for a vehicle of the initially mentioned kind, where the charge level may be maintained in the energy storage even when the vehicle is driven at a low speed during a longer period.

According to the invention, a control unit receives information concerning the charge level of the energy storage and determines if the charge level is lower than a limit level when the energy storage has a charging need. If the charge level is lower than the limit level, the rotation speed of the engine is increased in relation to the rotation speed when the energy storage has a charging need. The rotation speed of the combustion engine is increased to a value such that the charge level of the energy storage at least is prevented from sinking below a lowest acceptable level. Alternatively, the rotation speed of the combustion engine may be increased such that the charge level of the energy storage does not sink further. In this case, only the combustion engine is responsible for the operation of the vehicle. However, the rotation speed of the combustion engine is preferably increased such that it both operates the vehicle and the electric machine, such that electric energy is generated for the energy storage. When the charge level of the energy storage has increased above the limit level, the rotation speed of the combustion engine may be reduced again to a normal value.

According to an embodiment of the present invention, the control unit is adapted to receive information about the charge level of the energy storage when the vehicle has a lower speed than a predetermined speed and to determine if the charge level is lower than said limit level for normal operation of the vehicle. During a starting process of the vehicle, the electric machine initially rotates with a negative rotation speed such that the energy storage is charged. After that, the vehicle has started to roll, and the vehicle soon obtains a speed at which the electric machine must supply electric energy in order for the speed of the vehicle to be able to increase further. Shunting of heavy vehicles means that the vehicle is driven short distances at a low speed between start and stop. The vehicle is continuously driven with an engaged starting gear and the combustion engine works at idle running rotation speed. The electric machine is here responsible for a large part of the operation, such that electric energy is converted and the charge level of the energy storage sinks between each start and stop. During many such consecutive start and stops, or continuous shunting, the energy storage risks being discharged completely. If the control unit receives information which indicates that the charge level of the energy storage is below the limit level when the vehicle is driven with a speed below said predetermined speed, it increases the rotation speed of the combustion engine to a higher level than the idle running rotation speed. The rotation speed of the combustion engine is increased to a value such that it may be responsible for the operation of the vehicle. This prevents the charge level of the energy storage from sinking below a lowest acceptable charge level. Preferably, the rotation speed of the combustion engine is increased to a value such that it also charges the energy storage during operation.

According to an embodiment of the present invention, the control unit is adapted to control the rotation speed of the combustion engine when the charge level is lower than said limit level such that the rotor of the electric machine rotates in a direction of rotation which charges the energy storage. At a start of the vehicle, the rotor of the electric machine rotates initially with a negative rotation speed such that electric energy is supplied to the energy storage. When the vehicle starts rolling, the input shaft to the gear box obtains a successively increasing rotation speed, which reduces the negative rotation speed of the rotor of the electric machine when the rotation speed of the combustion engine is held constant. By increasing the rotation speed of the combustion engine concurrently, the vehicle obtains an increased speed, and the time during which the rotor of the electric machine rotates in a negative direction may be prolonged. The energy storage may thereby be charged during a relatively long time period after that the vehicle has started.

According to another preferred embodiment of the invention, the control unit is adapted to, on occasions when the charge level of the energy storage is lower than said limit level, grade the low charge level of the energy storage and increase the rotation speed of the combustion engine depending on this gradation. Such a gradation may, for example, be expressed in the difference/ratio, or the like, between the charge level of the energy storage and the limit level. Alternatively, the gradation may be done in several gradation steps, for example, low and very low charge level. In this case, the rotation speed of the combustion engine is increased more when the charge level of the energy storage is very low than when it is only low.

According to another preferred embodiment of the invention, the control unit is adapted to control the rotation speed of the combustion engine when the charge level is lower than the limit level with an increased rotation speed which is related to the rotation speed of the input shaft of the gear box. For a driver of the vehicle, it is important to feel that the operation of the vehicle follows the movements of the accelerator pedal. In this case, the combustion engine obtains an increased rotation speed when the speed of the vehicle increases. The difference that a driver experiences with such an operation in relation to an operation with a conventional vehicle is only that the vehicle is driven with a lower gear than the gear engaged in the gear box. The control unit may be adapted to control the combustion engine with an increased rotation speed which is related to a factor multiplied by the rotation speed of the input shaft of the gear box. The magnitude of the factor depends on the charge level of the energy storage. At a very low charge level in the energy storage, a higher factor is used than if the charge level is only low. As the charge level increases, the factor may be corrected.

According to an alternative embodiment of the present invention, the control unit is adapted to control the rotation speed of the combustion engine when the charge level is lower than the limit level with an increased rotation speed which is related to the demanded driving moment of the vehicle. In this case, the rotation speed of the combustion engine is increased concurrently with the driver pressing down on the accelerator pedal. During a normal starting process of the hybrid vehicle, the rotation speed of the combustion engine is initially substantially constant independent of the position of the accelerator pedal. The control unit may be adapted to control the combustion engine with an increased rotation speed which is related to a factor multiplied by the demanded driving moment of the vehicle. The magnitude of the factor depends also on the charge level of the energy storage. At a very low charge level of the energy storage, a higher factor is used than if the charge level is only low. Also here, said factor may be corrected when the charge level in the energy storage is changed.

According to a further alternative embodiment of the present invention, the control unit is adapted to control the combustion engine with an increased rotation speed related to a combination of the rotation speed of the input shaft of the gear box and the demanded driving moment of the vehicle. In this case, the combustion engine is controlled with an increased rotation speed which is determined by a combination of the above two alternatives. Preferably a factor is used which is related to the charge level in the energy storage.

According to another preferred embodiment of the invention, the output shaft of the combustion engine is connected to the sun wheel of the planetary gear, the input shaft of the gear box is connected to the planet wheel holder of the planetary gear and the rotor of the electric machine is connected to the ring wheel of the planetary gear. With such a design, the included components have a compact construction. The sun wheel and the planet wheel holder may be connected to the output shaft of the combustion engine and the input shaft of the gear box, respectively, with the help of spline joints, or the like. It is thereby guaranteed that the sun wheel rotates with the same rotation speed as the output shaft of the combustion engine and that the planet wheel holder rotates with the same rotation speed as the input shaft of the gear box. The rotor of the electric machine may be fixedly arranged on an external peripheral surface of the ring wheel. The internal peripheral surface of the ring wheel is normally provided with cogs. The external peripheral surface of the ring wheel is normally smooth and very well suited for carrying the rotor of the electric machine. The ring wheel and the rotor of the electric machine thereby form a rotatable unit. Alternatively, the rotor of the electric machine may be connected to the ring wheel via a transmission. It is however possible to connect the output shaft of the combustion engine, the input shaft of the gear box and the rotor of the electric machine with any of the other components of the planetary gear.

### SHORT DESCRIPTION OF THE DRAWINGS

In the following preferred embodiments of the invention are described, as examples, with reference to the annexed drawings, on which:

FIG. 1 shows a drive line of a vehicle with a drive system according to the present invention,

FIG. 2 shows the drive system in more detail,

FIG. 3 shows how different parameters may vary during a starting process of the vehicle in a normal operation,

FIG. 4 shows how different parameters may vary during a starting process of the vehicle in an operation in order to maintain the charge of the energy storage and

FIG. 5 shows how the charge level of the energy storage may vary during shunting.

### DETAILED DESCRIPTION OF PREFERRED EMBODIMENTS OF THE INVENTION

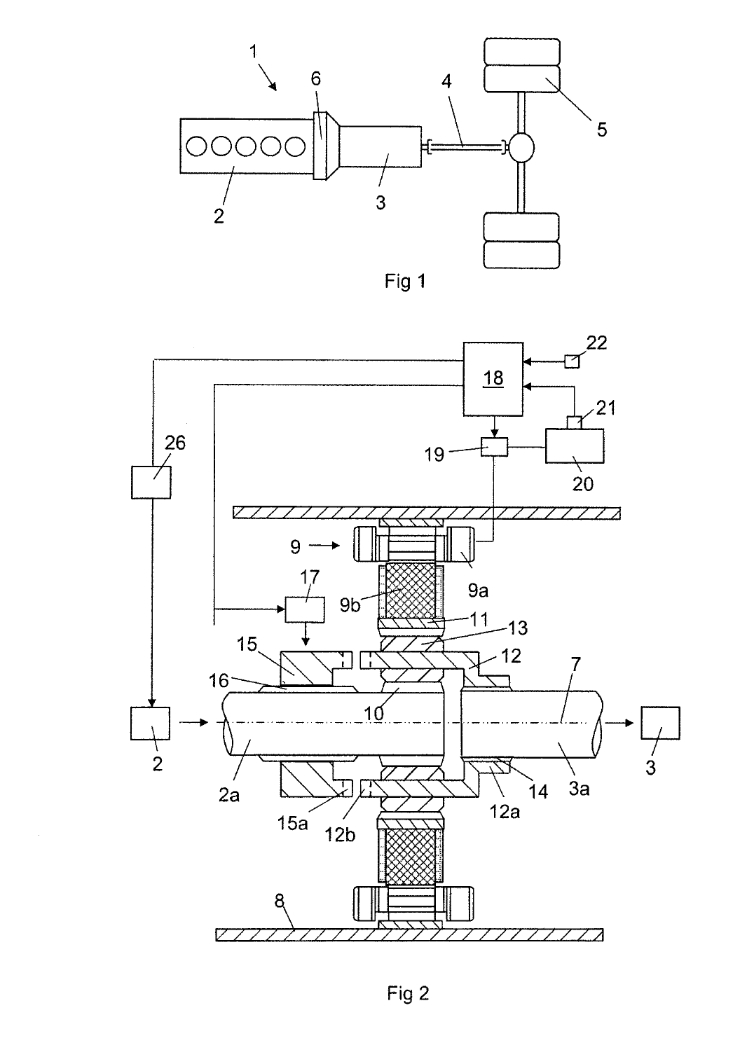

FIG. 1 shows a drive line for a heavy vehicle 1. The drive line comprises a combustion engine 2, a gear box 3, a number of drive shafts 4 and drive wheels 5. Between the combustion engine 2 and the gear box 3, the drive line comprises an intermediate part 6. FIG. 2 shows the components in the intermediate part 6 in more detail. The combustion engine 2 is provided with an output shaft 2a and the gear box 3 with an input shaft 3a in the intermediate part 6. The output shaft 2a of the combustion engine is coaxially arranged in relation to the input shaft 3a of the gear box. The output shaft 2a of the combustion engine and the input shaft 3a of the gear box are rotatably arranged around a common axis of rotation 7. The intermediate part 6 comprises a housing 8 which encloses an electric machine 9 and a planetary gear. The electric machine 9 comprises, in a customary manner, a stator 9a and a rotor 9b. The stator 9a comprises a stator core which is attached in a suitable manner on the inside of the housing 8. The stator core comprises the windings of the stator. The electric machine 9 is adapted to, during certain operation occasions, use stored electric energy for supplying drive power to the input shaft 3a of the gear box and, during other operation occasions, use the kinetic energy of the input shaft 3 of the gear box for generating and storing electric energy.

The planetary gear is arranged substantially radially inside of the stator 9a and rotor 9b of the electric machine. The planetary gear comprises, in a customary manner, a sun wheel 10, a ring wheel 11 and a planet wheel holder 12. The planet wheel holder 12 carries a number of cog wheels 13 which are rotatably arranged in a radial space between the cogs of the sun wheel 10 and the ring wheel 11. The sun wheel 10 is attached on a peripheral surface of the output shaft 2a of the combustion engine. The sun wheel 10 and the output shaft 2a of the combustion engine rotate as a unit with a first rotation speed n₁. The planet wheel holder 12 comprises an attachment portion 12a which is attached on a peripheral surface of the input shaft 3a of the gear box with the help of a spline joint 14. With the help of this joint, the planet wheel holder 12 and the input shaft 3a of the gear box rotate as a unit with a second rotation speed n₂. The ring wheel 11 comprises an external peripheral surface on which the rotor 9b is fixedly mounted. The rotor 9b and the ring wheel 11 constitute a rotatable unit which rotates with a third rotation speed n₃.

Since the intermediate part 6 between the combustion engine 2 and the gear box 3 in a vehicle is limited, it is required that the electric machine 9 and the planetary gear constitute a compact unit. The components 10-12 of the planetary gear are arranged substantially radially inside of the stator 9a of the electric machine. The rotor 9b of the electric machine, the ring wheel 11 of the planetary gear, the output shaft 2a of the combustion engine and the input shaft 3a of the gear box are rotatably arranged around a common axis of rotation 7. With such a design, the electric machine 9 and the planetary gear occupy a relatively small space.

The vehicle comprises a locking mechanism which is movable between a first open position in which the three components 10-12 of the planetary gear are allowed to rotate with different rotation speeds and a second locked position in which it locks together two of the components 10, 12 of the planetary gear such that the three components 10-12 of the planetary gear rotate with the same rotation speed. In this embodiment, the locking mechanism comprises a displaceable coupling member 15. The coupling member 15 is attached on the output shaft 2a of the combustion engine with the help of a spline joint 16. The coupling member 15 in this case is arranged on, and secured against turning with the output shaft 2a of the combustion engine and displaceably arranged in an axial direction on the output shaft 2a of the combustion engine. The coupling member 15 comprises a coupling portion 15a which is connectable to a coupling portion 12b of the planet wheel holder 12. The locking mechanism comprises a schematically shown displacement member 17 adapted to displace the coupling member 15 between the first free position I₁ where the coupling portions 15a, 12b are not in engagement with each other and the second locked position I₂ where the coupling portions 15a, 12b are in engagement with each other. In the first open position, the output shaft 2a of the combustion engine and the input shaft 3a of the gear box rotate with different rotation speeds. When the coupling portions 15a, 12b are in engagement with each other, the output shaft 2a of the combustion engine and the input shaft 3a of the gear box will rotate with the same rotation speed.

An electric control unit 18 is adapted to control the displacement member 17. The control unit 18 is also adapted to decide at which occasions the electric machine 9 is to work as a motor and on which occasions it is to work as a generator. In order to decide this, the control unit 18 receives actual information from suitable operation parameters. The control unit 18 may be a computer with suitable software for this purpose. The control unit 18 also controls schematically shown control equipment 19 which controls the flow of electric energy between an energy storage 20 and the stator 9a of the electric machine. When the electric machine 9 works as a motor, stored electric energy from the energy storage 20 is supplied to the stator 9a. When the electric machine works as a generator, electric energy from the stator 9a is supplied to the energy storage 20. The energy storage 20 delivers and stores electric energy with a rated output on the order of 200-800 Volts. The control unit 18 receives information from a measurement instrument 21 concerning the charge level q of the energy storage. The control unit 18 receives information from a sensor 22 which senses the position of an accelerator pedal. The position of the accelerator pedal corresponds to the driving moment that the driver wishes to supply to the vehicle 1. The vehicle 1 is equipped with a motor control function 26 with which the rotation speed n₁ of the combustion engine may be controlled. The control unit 18, for example, may activate the motor control function 26 during engagement and disengagement of gears in the gear box 3 in order to create a momentless state in the gear box 3.

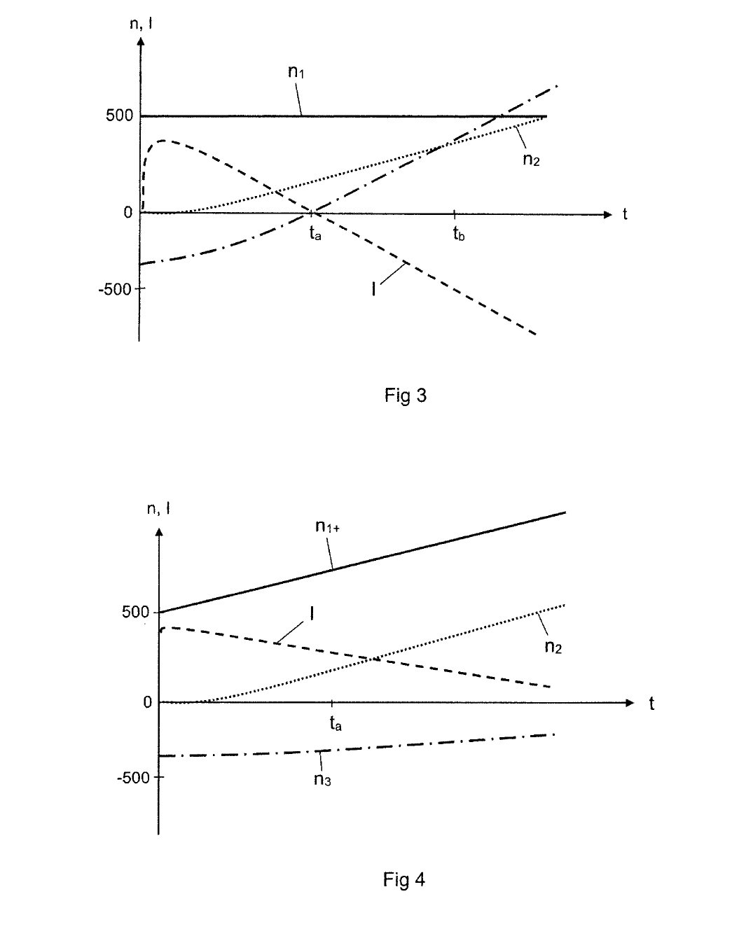

FIG. 3 shows a starting process of the vehicle where the control unit 18 has received information from the measurement instrument 21 which indicates that the charge level q of the battery is equal to or higher than a limit level q₀ which the energy storage 20 should have during the start in order for the vehicle 1 to be able to be started in a normal manner. The control unit 18 will thereby carry out a normal start of the vehicle and control the motor control function 26 such that the combustion engine 2 maintains its idle running rotation speed during the starting process. FIG. 3 shows, in the form of curves, how the rotation speed n₁ of the output shaft of the combustion engine, the rotation speed n₂ of the input shaft of the gear box, the rotation speed n₃ of the electric machine and the current Ito the energy storage 20 may vary during such a normal starting process of the vehicle 1. The rotation speed n₁ of the output shaft of the combustion engine is shown with a continuous line, the rotation speed n₂ of the input shaft of the gear box is shown with a dotted line, the rotation speed n₃ of the electric machine is shown with a dashed-dotted line and the current Ito the energy storage 20 is shown with a dashed line. The ratio between the number of cogs z₁ of the sun wheel 9 and the number of cogs z₂ of the ring wheel 10 is, in this example, z₁/z₂=0.7.

At t=0, the combustion engine 2 has started and is operated with an idle running rotation speed which, in this case, is 500 rpm. The input shaft 3a of the gear box is not rotating and has an initial rotation speed n₂=0 rpm. Since all the components in the planetary gear are connected to each other with a predetermined transmission ratio, the ring wheel 11 initially obtains a rotation speed n₃ which is determined by the two other rotation speeds n₁, n₂. With the above mentioned transmission ratio z₁/z₂=0.7, the ring wheel obtains that rotation speed n₃=−350 rpm. The ring wheel 11 thus initially rotates in an opposite direction in relation to the sun wheel 10. The control unit 18 controls the control mechanism 19 such that the electric machine 9 provides a moment which brakes the ring wheel 11. Thereby, electric energy is generated and current I is initially led from the electric machine 9 to the energy storage 20. The input shaft 3a of the gear box obtains a driving moment which is determined by the moment of the combustion engine and the braking moment of the electric machine. This moment will act on the input shaft 3a of the gear box such that it starts to rotate, i.e. n₂ becomes larger than zero and the vehicle 1 starts.

The control unit 18 receives information from the sensor 22 concerning the position of the accelerator pedal and controls the control mechanism 19 such that the electric machine and the combustion engine supply a moment to the input shaft 3a of the gear box such that the vehicle 1 obtains the driving moment indicated by the position of the accelerator pedal. The control unit 18 controls the engine rotation speed function 26 such that the rotation speed n₁ of the combustion engine is held constant. When the rotation speed n₂ of the input shaft of the gear box increases, this results in the negative rotation speed n₃ of the electric machine 9 being reduced when the rotation speed n₁ of the combustion engine at the same time is constant. At the time tₐ, the rotation speed n₂ of the input shaft of the gear box has increased to a value such that the negative rotation speed n₃ of the electric machine has been completely eliminated. The time tₐ may be on the order of magnitude of 0.5 seconds. During the continued operation, the rotor 11 of the electric machine rotates with a positive rotation speed n₃. Electric energy from the energy storage 20 will thereby be consumed and a current I is led from the energy storage 20 to the electric machine 9. After the time tₐ has passed, the current

I which is led from the energy storage to the electric machine 9 increases with the rotation speed n₂ of the input shaft of the gear box and the speed of the vehicle. At the time t_{b}, approximately the same current has been consumed as initially generated in the energy storage 20 during the starting process. The time t_{b} may be on the order of magnitude of 1 second. During the continued operation of the vehicle with the combustion engine 2 at an idle running rotation speed and with engaged starting gear, a relatively large amount of electric energy is consumed. If the vehicle 1, during a longer period, is operated in such an operation condition, the charge level of the energy storage sinks substantially. This may, for example, be the case during shunting, when the vehicle 1 is driven short distances at a low speed between start and stop. If a normal operation is used, there is a risk that the energy storage 20 discharges completely.

FIG. 4 shows a starting process of the vehicle where the control unit 18 has received information from the measurement instrument 21 which indicates that the charge level q of the battery is lower than the limit level qₒ that the energy storage 20 should have during the start in order for the vehicle to be able to be started and operated in a normal manner. The energy storage 20 has a charging need since the charge level q is below the limit level q₀. The control unit 18 also notes how much lower the charge level q is than the limit level q₀. In a corresponding manner, as in FIG. 3, the combustion engine 2 has, at t=0, an idle running rotation speed of 500 rpm, the input shaft 3a of the gear box has a rotation speed n₂=0 rpm and the rotor 9b of the electric machine has a rotation speed n₃=−350 rpm. The control unit 18 will, in this case, provide an alternative operation of the vehicle 1 in order to maintain that the charge level q of the energy storage.

The control unit 18 receives information from the sensor 22 concerning the position of the accelerator pedal and thereby the driving moment which the driver wishes to supply to the vehicle 1. With the help of this information, the control unit 18 controls the control mechanism 19 and the motor control function 26 such that the electric machine 9 and the combustion engine 2 gives the input shaft of the gear box a moment which corresponds to the desired driving moment of the vehicle 1. In this case, the control unit 18 controls the motor control function 26 such that the combustion engine 2 obtains an increased rotation speed n₁₊which is related to a factor multiplied by the rotation speed n₂ of the input shaft of the gear box and the speed of the vehicle with the engaged gear in the gear box 3. The magnitude of said factor depends on how low the charge level q of the energy storage is in relation to the limit level q₀. At a charge level q in the energy storage 20, which is clearly below the limit level q₀, a higher factor is used than if the charge level q in the energy storage 20 is more marginally below the limit level q₀. Since the rotation speed n₁ of the combustion engine increases with the rotation speed n₂ of the input shaft of the gear box, the negative rotation speed n₃ of the rotor 9b of the electric machine may be maintained during a longer time period than the time tₐ. Current I is thereby supplied to the energy storage 20 during a prolonged time period which results in the charge level q in the energy storage 20 increasing. The relation between the rotation speed n₁ of the combustion engine and the increased speed of the vehicle is experienced as natural by the driver.

Alternatively, the control unit 18 may control the motor control function 26 such that the combustion engine obtains an increased rotation speed n₁₊which is related to a factor multiplied by the demanded driving moment of the vehicle. The magnitude of said factor depends on how low the charge level q of the energy storage is in relation to the limit level qₒ. If the driver wishes to drive the vehicle with a constant driving moment, the rotation speed n₁ of the combustion engine increased with time in a corresponding manner as is shown in FIG. 4. Also in this case, the negative rotation speed n₃ of the rotor 9b of the electric machine is maintained during a longer time period than the time tₐ. Current I is thus led during a longer time period from the electric machine 9 to the energy storage 20, which results in the charge level q of the energy storage 20 increasing. In this case, the rotation speed of the combustion engine increases as the accelerator pedal is pressed down, which is also experienced as natural by a driver. The experience, in this case, will be the same as at a start with a heavy load of a conventional vehicle, where the rotation speed is increased if the moment of the combustion engine 2, when running idle, is not sufficient for starting the vehicle 1.

According to a further alternative, the control unit 18 may control the motor control function 26 such that the combustion engine obtains an increased rotation speed n₁₊ which is both related to a factor multiplied by the rotation speed n₂ of the input shaft of the gear box and a factor multiplied by the demanded driving moment of the vehicle. To determine the increased rotation speed n₁₊ of the combustion engine by means of a factor multiplied by the rotation speed n₂ of the input shaft of the gear box may be termed as a first method. To determine the increased rotation speed n₁₊ of the combustion engine by means of a factor multiplied by the demanded driving moment of the vehicle may be termed as a second method. In this case, may, for example, whichever of the two methods resulting in the highest value of the increased rotation speed n₁₊ to be controlling during prevailing operation occasions. It is also possible that a linear combination of the two methods is used to determine the increased rotation speed n₁₊ of the combustion engine. A linear combination means that the increased rotation speed n₁₊ of the combustion engine is determined by means of a weighted combination of the two methods. The increased rotation speed n₁₊ of the combustion engine may, for example, be 40% of one of the methods and to 60% of the other method. The ratio between the methods may vary during different operational conditions.

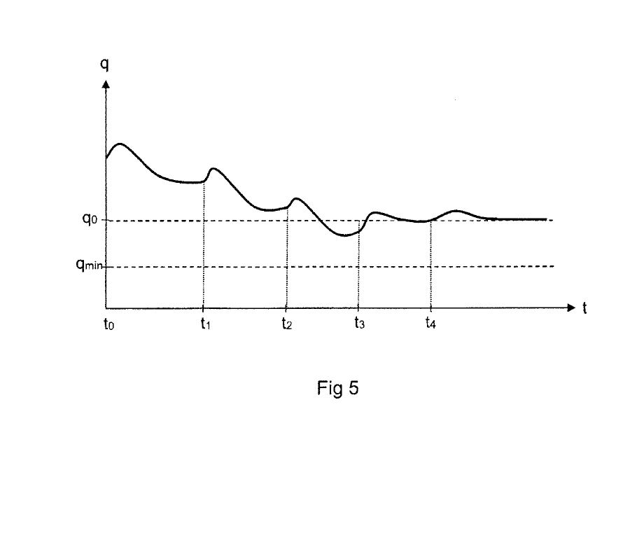

FIG. 5 shows how the charge level q of the energy storage may change during a shunting operation of the hybrid vehicle 1. The charge level qₘᵢₙ means that the energy storage is almost completely discharged. The charge level qₘᵢₙ must, under all circumstances, be maintained. At the time t=0, the vehicle 1 starts. The control unit 18 receives information from the measurement instrument 21 which indicates that the charge level q of the energy storage 20 clearly exceeds the limit level q₀. The vehicle 1 may thereby be started and operated in a normal manner. During the operation process, the charge level of the energy storage 20 increases initially and will then sink to a lower charge level at the time t_{q} when the driver stops the vehicle. The charge level q of the energy storage 20 follows a substantially correspondingly shaped curve as the current curve in FIG. 3. At the time t₁, the vehicle 1 starts again. The control unit 18 receives information from the measurement instrument 21 which indicates that the charge level q of the energy storage 20 still exceeds the limit level q₀. The vehicle 1 may thereby be started and driven in a normal manner. The vehicle 1 is stopped and starts thereafter substantially directly again at the time t₂ and the procedure according to the above is repeated. The charge level q of the energy storage sinks successively for each start and stop of the vehicle during normal operation when the vehicle 1 is driven at a low speed and with the starting gear engaged. When the vehicle 1 is to start at the time t₃, the charge level q of the energy storage 20 has sunk to a lower level than the limit level q₀. The control unit 18 estimates how much lower the charge level q is than the limit level q₀. The control unit 18 controls the combustion engine 2 with an increased rotation speed n₁₊ which is related to a factor f multiplied by the rotation speed n₂ of the input shaft of the gear box or a demanded driving moment of the vehicle. Said factor is thus related to how much lower the charge level q is than the limit level q₀. In this case, the charge level of the energy storage 20 is increased in a corresponding manner as at a normal start. The charge level q of the battery follows a substantially correspondingly shaped curve as the current curve I in FIG. 4. The charge level q of the energy storage increases initially to a level above the limit level q₀, after which it falls down to the limit level q₀. The vehicle stops and starts again at t₄. The control unit 18 may correct said factor during the operation when the charge level q of the energy storage 20 changes in relation to the limit level q₀.

At t₄, the energy storage 20 has a charge level q which corresponds to the limit level q₀. The vehicle 1 is thereby given a normal start. The charge level increases initially, after which it sinks down towards the limit level q₀. In this case, the charge level of the energy storage is prevented from sinking below the limit level q₀. The control unit 18 receives continuous information from the measurement instrument 21. When the control unit 18 receives information which indicates that the charge level q of the energy storage has sunk down to the limit level qₒ, the control unit 18 increases the rotation speed n₁ of the combustion engine such that the charge level q of the energy storage does not sink further. Thereafter, the control unit 18 controls the rotation speed of the combustion engine such that the charge level does not fall under the limit level q₀. As soon as the vehicle reaches a speed v₂ at which the coupling member may be displaced to the first position, the energy storage may be charged by the combustion engine 2 since it, in this position, is connected to the electric machine 9.

The invention is in no way limited to the embodiment described in the drawings but may be varied freely within the scope of the claims. For example, a transmission with a gear ratio may be arranged between the rotor 9 and the ring wheel 11. The rotor 9 and the ring wheel 11 need not rotate with the same rotation speed.

1. A drive system for a vehicle comprising:
a combustion engine including an output shaft;
a motor control configured to control a rotation speed of the combustion engine and the output shaft;
a gear box including an input shaft;
an electric machine which comprises a stator and a rotor;
an energy storage connected to the electric machine;
a planetary gear which comprises a sun wheel, a ring wheel and a planet wheel holder;
the output shaft of the combustion engine is connected to a first one of the sun wheel, the ring wheel and the planetary wheel holder of the planetary gear such that rotation of the output shaft causes rotation of the first component, the input shaft of the gear box is connected to a second one of the sun wheel, the ring wheel and the planet wheel holder of the planetary gear such that rotation of the input shaft causes rotation of the second component, and the rotor of the electric machine is connected to a third one of the sun wheel, the ring wheel and the planet wheel holder of the planetary gear such that rotation of the rotor causes rotation of the third component;
a control unit configured to receive information concerning a charge level of the energy storage, to determine if the charge level of the energy storage is lower than a limit level at which the energy storage has a charging need, and the motor control is configured to control the combustion engine to provide an increased rotation speed compared to a rotation speed of the engine when the energy storage does not have a charging need, when the charge level is below the limit level.

2. The drive system according to claim 1, wherein the control unit receives the information concerning the charge level of the energy storage when the vehicle has a lower speed than a predetermined speed and determines if the charge level is lower than the limit level, which defines a charge necessary for starting the vehicle during normal operation.

3. The drive system according to claim 1, wherein the control unit is configured to control the rotation speed of the combustion engine when the charge level is lower than the limit level such that the rotor of the electric machine rotates in a direction in which the rotor charges the energy storage.

4. The drive system according to claim 1, wherein when the charge level of the energy storage is lower than the limit level, the control unit is configured to grade the charge level of the energy storage and to increase the rotation speed of the combustion engine depending on the grading.

5. The drive system according to claim 1, wherein the control unit is configured to control the rotation speed of the combustion engine when the charge level is lower than the limit level and is configured to provide the increased rotation speed which is related to a rotation speed of the input shaft of the gear box.

6. The drive system according to claim 5, wherein the control unit is configured to control the combustion engine to provide the increased rotation speed which is related to a factor multiplied by the rotation speed of the input shaft of the gear box.

7. The drive system according to claim 1, wherein the control unit is configured to control the rotation speed of the combustion engine when the charge level is lower than the limit level to provide the increased rotation speed which is related to a demanded driving moment of the vehicle .

8. The drive system according to claim 7, wherein the control unit is configured to control the combustion engine to provide the increased rotation speed which is related to a factor multiplied by the demanded driving moment of the vehicle.

9. The drive system according to claim 5, wherein the control unit is configured to control the combustion engine to provide the increased rotation speed which is related to a combination of the rotation speed of the input shaft of the gear box and a driver's demanded driving moment of the vehicle.

10. The drive system according to claim 1, wherein the output shaft of the combustion engine is connected to the sun wheel of the planetary gear, the input shaft of the gear box is connected to the planet wheel holder of the planetary gear, and the rotor of the electric machine is connected to the ring wheel of the planetary gear.

11. A method of driving a vehicle, wherein the vehicle comprises:
a combustion engine including an output shaft,
a motor control configured to control a rotation speed of the combustion engine,
a gear box including an input shaft,
an electric machine which comprises a stator and a rotor,
an energy storage which is connected to the electric machine, and
a planetary gear which comprises a sun wheel, a ring wheel and a planet wheel holder;
the output shaft of the combustion engine is connected to a first one of the sun wheel, the ring wheel and the planet wheel carrier of the planetary gear such that rotation of the output shaft causes rotation of the first component, the input shaft of the gear box is connected to a second one of the sun wheel, the ring wheel and the planet wheel carrier of the planetary gear such that rotation of the input shaft causes rotation of the second component, and the rotor of the electric machine is connected to a third one of the sun wheel, the ring wheel and the planet wheel carrier of the planetary gear such that rotation of the rotor causes rotation of the third component,:
the method comprising steps of:
receiving information concerning a charge level of the energy storage, to determine if the charge level is lower than a limit level at which the energy storage has a charging need; and
controlling the combustion engine to provide an increased rotation speed compared to a rotation speed of the combustion engine when the energy storage does not have any charging need.

12. The method according to claim 11, wherein the step of receiving information concerning the charge level of the energy storage occurs when the vehicle has a lower speed than a predetermined speed and the information is used to determine if the charge level is lower than the limit level.

13. The method according to claim 11, further comprising controlling the rotor of the electric machine to rotate in a direction in which the rotor charges the energy storage, when the charge level is lower than the limit level.

14. The method according to claim 11, further comprising grading the charge level of the energy storage and providing the combustion engine with the increased rotation speed dependent on this grading, when the charge level is lower than the limit level.

15. The method according to claim 11, wherein the increased rotation speed is related to the rotation speed of the input shaft of the gear box when the charge level is lower than the limit level.

16. The method according to claim 15, wherein the increased rotation speed is related to a factor multiplied by the rotation speed of the input shaft of the gear box.

17. The method according to claim 11, wherein the increased rotation speed is related to a demanded driving moment of the vehicle when the charge level is lower than the limit level.

18. The method according to claim 17, wherein the increased rotation speed is related to a factor multiplied by the demanded driving moment of the vehicle when the charge level is lower than the limit level.

19. The method according to claim 15, wherein the increased rotation speed is related to a combination of the rotation speed of the input shaft of the gear box and the demanded driving moment of the vehicle.

20. The method according to claim 11, further comprising connecting the output shaft of the combustion engine to the sun wheel of the planetary gear, connecting the input shaft of the gear box to the planet wheel holder of the planetary gear and connecting the rotor of the electric machine to the ring wheel of the planetary gear.

21. A computer program product including a non-transitory data storage medium and a computer program comprising computer program code readable by a computer stored on the medium, the code enabling a computer to implement a method according to claim 11 when the computer program code is executed in the computer.

22. (canceled)

23. A vehicle comprising a drive system according to claim 1.
